(19) United States
(12) Patent Application Publication
(10) Pub. No.: US 2026/0122707 A1
(43) Pub. Date: Apr. 30, 2026

(54) COMMUNICATION APPARATUS CAPABLE OF WIRELESS COMMUNICATION, CONTROL METHOD, AND MEDIUM

(71) Applicant: CANON KABUSHIKI KAISHA, Tokyo (JP)

(72) Inventor: YUJI KAWAI, Kanagawa (JP)

(21) Appl. No.: 19/369,860

(22) Filed: Oct. 27, 2025

(30) Foreign Application Priority Data
Oct. 30, 2024 (JP) 2024-190705

(51) Int. Cl. H04W 76/15; H04W 48/16; H04W 72/30

(52) U.S. Cl. CPC H04W 76/15; H04W 48/16; H04W 72/30

(57) ABSTRACT

A communication apparatus that wirelessly communicates with a communication partner apparatus includes a processor, and a memory storing a program which, when executed by the processor, causes the communication apparatus to execute search processing that searches for the communication partner apparatus, and execute display control processing that controls a display unit to display predetermined beacon information in a manner that enables the predetermined beacon information to be identified as being multi-link-supported information when a plurality of pieces of beacon information obtained by search performed includes the predetermined beacon information including support information indicating that information is multi-link-supported information.

### BACKGROUND

### Field of the Technology

The present disclosure relates to a communication apparatus, a control method, and a medium.

### Description of the Related Art

Due to the recent integration of wireless communication devices, not only a portable personal computer (PC) (so-called laptop PC) but also a printer, a portable information terminal, a digital camera, a smart device, a smartphone, and the like have become equipped with a wireless local area network (LAN) function. Accordingly, devices that have conventionally had only a communication unit by wired connection with a specific device, such as universal serial bus (USB) connection, have become able to perform data communication with various devices by having a wireless communication unit. For example, Japanese Patent Laid-Open No. 2011-120279 describes an electronic camera that transfers an image after selecting any of a server, a PC, or a printer.

As communication standards of the wireless LAN, there are Institute of Electrical and Electronics Engineers (IEEE) 802.11 standards. In the IEEE 802.11be being the latest standard, a function called a multi-link operation (MLO) has been added. Conventionally, an access point (AP) and a communication terminal have performed communication by constructing a single link in any frequency band of a 2.4-gigahertz (GHz) band, a 5-GHz band, and a 6-GHz band. In contrast to this, the MLO can perform communication by simultaneously constructing a plurality of links in a plurality of frequency bands from the 2.4-GHz band, the 5-GHz band, and the 6-GHz band. Because the MLO have effects such as throughput improvement, reliability improvement, and delay reduction, it has been demanded to prompt users to actively establish connection. Nevertheless, when a communication terminal searches for a nearby AP and displays an AP search result as a list, users cannot identify whether a displayed network is an MLO-supported network, only by displaying a network name (service set identifier (SSID)).

### SUMMARY

In view of the foregoing, the present disclosure is directed to enabling users to identify whether a displayed network is an MLO-supported network, when displaying an AP search result as a list.

To achieve the above-described objective, according to an aspect of the present disclosure, a communication apparatus according to the present disclosure is a communication apparatus that can wirelessly communicate with a communication partner apparatus, and the communication apparatus includes a search unit configured to search for the communication partner apparatus, and a display control unit configured to control a display unit to display predetermined beacon information in a manner that enables the predetermined beacon information to be identified as being multi-link-supported information when a plurality of pieces of beacon information obtained by search performed by the search unit includes the predetermined beacon information including support information indicating that information is multi-link-supported information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a communication apparatus according to the present embodiment.

FIG. 2 is a diagram of an exemplary network configuration according to the present embodiment.

FIGS. 3A-3H are diagrams each exemplifying information included in a beacon received by a communication apparatus according to the present embodiment.

FIGS. 4A-4C are flowcharts illustrating processing to be executed by a communication apparatus according to a first embodiment.

FIGS. 5A-5B are diagrams each exemplifying information to be stored when a beacon received by the communication apparatus according to the first embodiment is stored in association.

FIGS. 6A-6B are diagrams exemplifying a screen displaying and expanding gathered service set identifiers (SSIDs) that is to be displayed on the communication apparatus according to the first embodiment.

FIGS. 7A-7D are diagrams exemplifying a screen displaying gathered SSIDs in a highlighted manner that is to be displayed on the communication apparatus according to the first embodiment.

FIG. 8 is a diagram of an exemplary screen for displaying that SSIDs are related SSIDs without gathering the SSIDs that is to be displayed on the communication apparatus according to the first embodiment.

FIGS. 9A-9B are diagrams exemplifying a screen gathering only single-link SSIDs that is to be displayed on the communication apparatus according to the first embodiment.

FIGS. 10A-10B are diagrams exemplifying a screen displaying gathered SSIDs in an upper part that is to be displayed on the communication apparatus according to the first embodiment.

FIGS. 11A-11B are flowcharts illustrating processing to be executed by a communication apparatus according to a second embodiment.

FIG. 12 is a diagram of an exemplary multi-link connectable SSID is associated according to the second embodiment.

FIGS. 13A-13B are diagrams exemplifying that a multi-link connectable SSID and other SSIDs are separated according to the second embodiment.

FIG. 14 is a diagram of exemplary SSIDs that are displayed in order of a radio field intensity according to the second embodiment.

FIGS. 15A-15B are flowcharts illustrating processing to be executed by a communication apparatus according to a third embodiment.

FIGS. 16A-16F are diagrams exemplifying screens to be displayed on the communication apparatus according to the third embodiment.

### DESCRIPTION OF THE EMBODIMENTS

Hereinafter, desired embodiments of the present disclosure will be described in detail based on the accompanying drawings. The embodiment to be described below is an example for carrying out the present disclosure, and is to be appropriately modified or changed depending on the configuration of an apparatus to which the present disclosure is applied, and various conditions, and the present disclosure is not limited to the configuration of the following embodiment. In addition, the embodiments to be described below may be partially combined.

### First Embodiment

Hereinafter, processing will be described in which a communication apparatus 100 compares a basic service set identifier (BSSID) (also referred to as an identifier) included in a single-link beacon transmitted from a multi-link operation (MLO)-supported access point (AP), and a BSSID included in a multi-link beacon transmitted from the same AP, and manages the matching BSSIDs in association. The AP is an example of a communication partner apparatus, and the communication apparatus 100 can wirelessly communicate with an AP. The MLO is a multi-link operation of Institute of Electrical and Electronics Engineers (IEEE) 802.11be.

### Configuration of Communication Apparatus 100

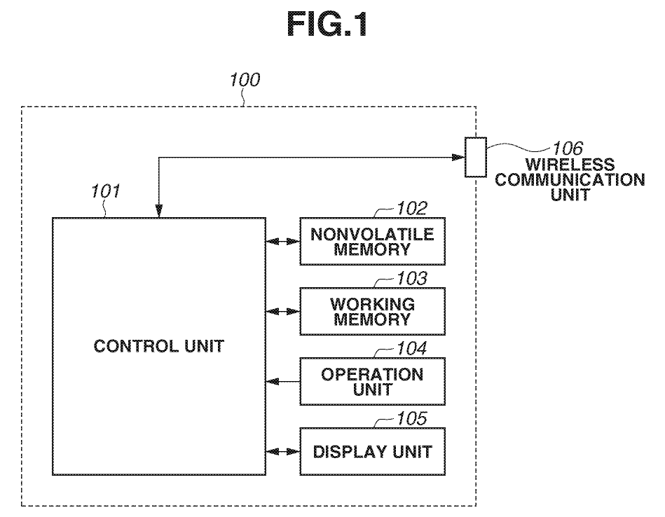

First of all, configurations and functions of the communication apparatus 100 according to the present embodiment will be described with reference to FIG. 1.

FIG. 1 is a block diagram a configuration example of the communication apparatus 100 according to the present embodiment. For example, the communication apparatus 100 may be a smartphone, a tablet device, a digital camera, or a personal computer that is equipped with a wireless function.

A control unit 101 controls each component of the communication apparatus 100 based on an input signal and a program to be described below. Instead of the control unit 101 controlling the entire apparatus, a plurality of hardware components may control the entire apparatus by sharing processing.

A nonvolatile memory 102 is an electrically erasable recordable nonvolatile memory. In the nonvolatile memory 102, an operating system (OS) being basic software that is to be executed by the control unit 101, and an application that implements an applicative function in cooperation with the OS are recorded. In addition, in the present embodiment, in the nonvolatile memory 102, an application for processing a beacon received from an AP is stored.

A working memory 103 is used as an image display memory of a display unit 105, a working area of the control unit 101, or the like.

An operation unit 104 is used to receive an instruction to the communication apparatus 100 from the user. For example, the operation unit 104 includes operation members such as a power button for the user issuing an instruction to turn ON/OFF the power of the communication apparatus 100, and a touch panel formed on the display unit 105.

The display unit 105 displays image data and characters for interactive operations. The display unit 105 need not always be included in the communication apparatus 100. The communication apparatus 100 is able to connect to the display unit 105, and have at least a display control function of controlling display on the display unit 105.

A wireless communication unit 106 is a communication interface for connecting to an external apparatus, and includes one or more communication circuits or communication modules. In accordance with the control of the control unit 101, the wireless communication unit 106 according to the present embodiment executes wireless communication compliant with an IEEE 802.11 standard, for example. In the present embodiment, the wireless communication unit 106 is used for the communication with an AP being an external apparatus.

Heretofore, an example of the configuration of the communication apparatus 100 has been described. A functional configuration included in the communication apparatus 100 is not limited to the above-described example. For example, the communication apparatus 100 may have an image capturing function.

### Network Configuration

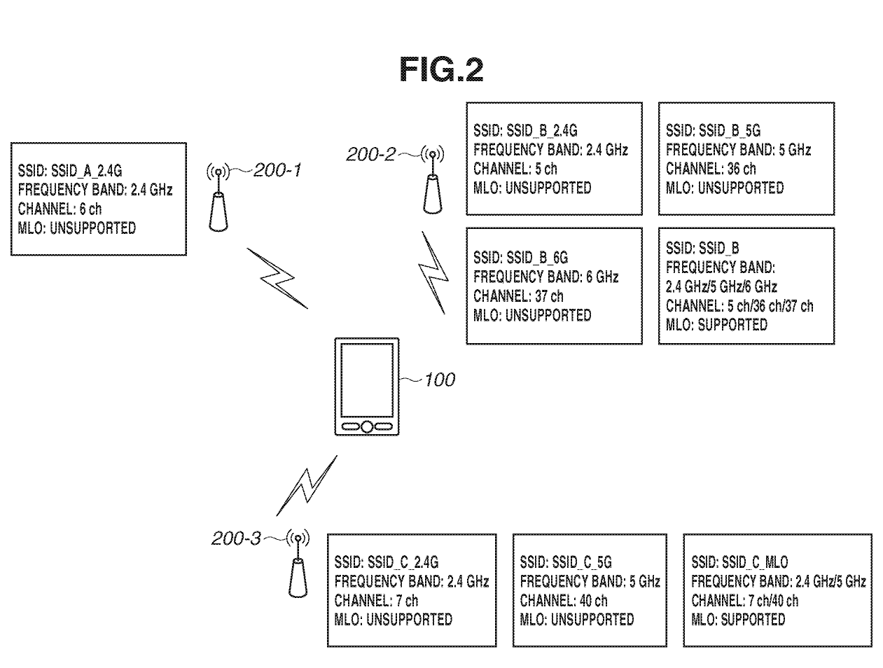

Next, a network configuration according to the present embodiment will be described with reference to FIG. 2.

FIG. 2 is a diagram schematically illustrating a network configuration according to the present embodiment. As illustrated in FIG. 2, in the present embodiment, three APs 200 exist around the communication apparatus 100.

At this time, the AP 200-1 constructs an MLO-unsupported network of which a service set identifier (SSID) is SSID_A_2.4G, a frequency band is 2.4 GHz, and a channel is 6.

The AP 200-2 constructs an MLO-unsupported network of which an SSID is SSID_B_2.4G, a frequency band is 2.4 GHz, and a channel is 5, and an MLO-unsupported network of which an SSID is SSID_B_5G, a frequency band is 5 GHz, and a channel is 36. Furthermore, the AP 200-2 constructs an MLO-unsupported network of which an SSID is SSID_B_6G, a frequency band is 6 GHz, and a channel is 37. Furthermore, the AP 200-2 constructs an MLO-supported (also be referred to as a multi-link-supported) network of which an SSID is SSID_B, frequency bands are 2.4 GHz, 5 GHz, and 6 GHz, and channels are 5, 36, and 37.

The AP 200-3 constructs an MLO-unsupported network of which an SSID is SSID_C_2.4G, a frequency band is 2.4 GHz, and a channel is 7, and an MLO-unsupported network of which an SSID is SSID_C_5G, a frequency band is 5 GHz, and a channel is 40. Furthermore, the AP 200-3 constructs an MLO-supported network of which an SSID is SSID_C_MLO, frequency bands are 2.4 GHz and 5 GHz, and channels are 7 and 40.

### Information Included in Beacon Received by Communication Apparatus 100

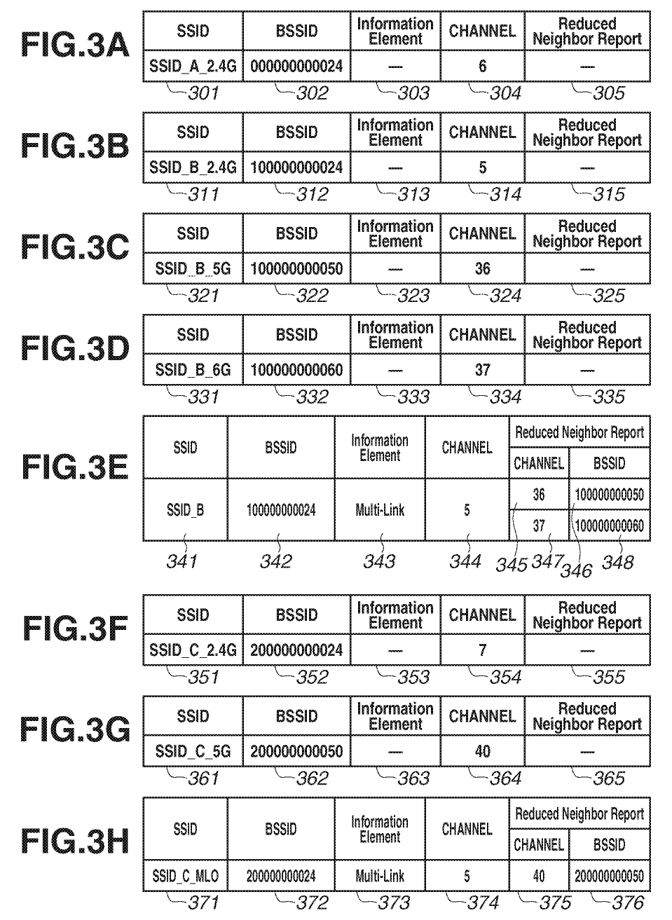

Next, information included in a beacon received by the communication apparatus 100 according to the present embodiment will be described with reference to FIG. 3A-3H.

FIGS. 3A-3H are diagrams exemplifying information (an example of beacon information) included in a beacon received by the communication apparatus 100 according to the present embodiment. In the present embodiment, the AP 200-1 illustrated in FIG. 2 transmits a beacon illustrated in FIG. 3A. In addition, the AP 200-2 illustrated in FIG. 2 transmits beacons illustrated in FIGS. 3B to 3E. In addition, the AP 200-3 transmits beacons illustrated in FIGS. 3F to 3H. As illustrated in FIGS. 3A-3H, a beacon includes an SSID (will also be referred to as an identification name), a BSSID, an Information Element (hereinafter, IE), a channel, and a Reduced Neighbor Report (hereinafter, RNR). In the case of an MLO-supported network, an RNR includes information regarding a frequency band other than a frequency band in which a beacon is transmitted. For example, in a case where a beacon is transmitted in a 2.4-GHz band in an MLO-supported network of 2.4 GHz and 5 GHz, an RNR includes information (channel, BSSID, etc.) regarding a 5-GHz band. In the present embodiment, the above-described information will be described as information included in a beacon, but information included in a beacon is not limited to this.

<AP Search and Association Processing to be Executed by Communication Apparatus 100>

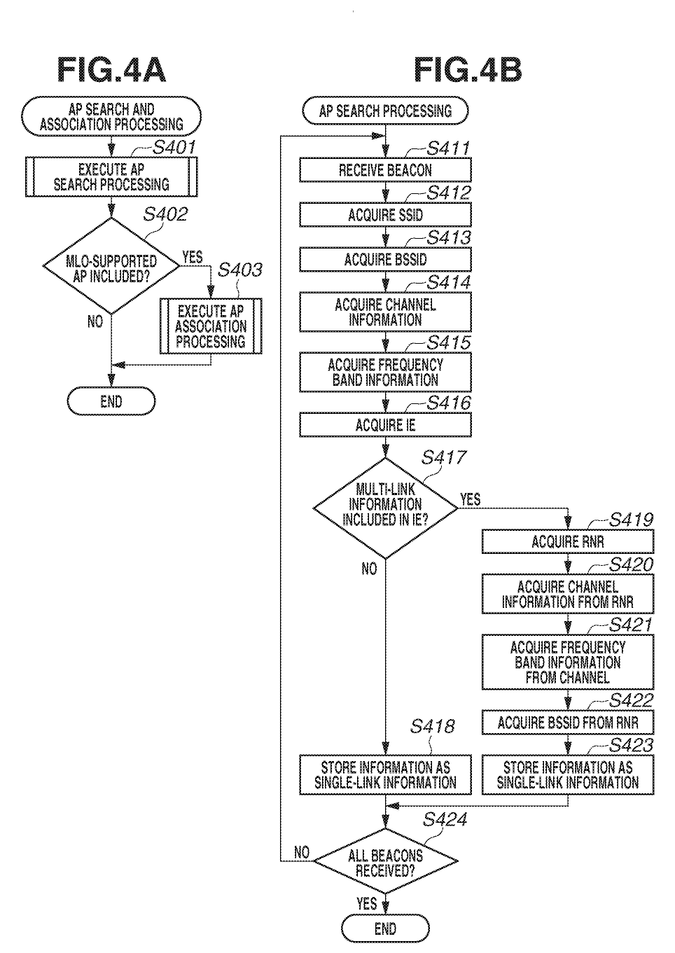

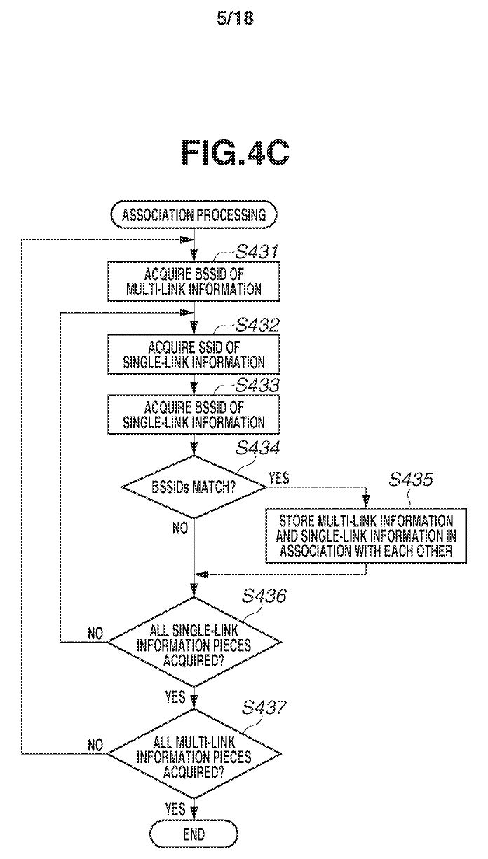

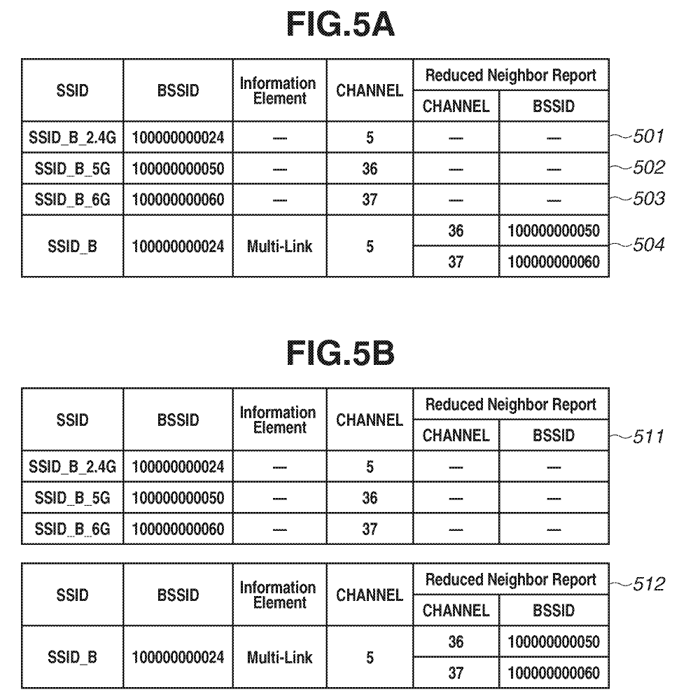

Next, AP search and AP information association processing to be executed by the communication apparatus 100 according to the present embodiment will be described with reference to FIGS. 4A-4C and FIGS. 5A-5B. In this example, the communication apparatus 100 according to the present embodiment receives beacons from the AP 200-1 and the AP 200-2.

FIG. 4A is a flowchart illustrating processing to be executed when the communication apparatus 100 according to the present embodiment executes AP search, and associates AP information acquired by the search.

In step S401, the control unit 101 searches for an AP existing in the vicinity, via the wireless communication unit 106. The details of the AP search processing will be described below with reference to FIG. 4B.

In step S402, the control unit 101 determines whether an MLO-supported AP is included in APs found in step S401. In a case where the control unit 101 determines that an MLO-supported AP is included (YES in step S402), the control unit 101 advances the processing to step S403. In a case where the control unit 101 determines that an MLO-supported AP is not included (NO in step S402), the control unit 101 ends the processing.

In step S403, the control unit 101 performs association processing of APs found in step S401. The details of the AP association processing will be described below with reference to FIG. 4C.

FIG. 4B is a flowchart illustrating processing to be executed when the communication apparatus 100 according to the present embodiment executes AP search, and illustrates the details of the processing in step S401 of FIG. 4A.

In step S411, the control unit 101 receives a beacon transmitted by an AP existing in the vicinity, via the wireless communication unit 106. At this time, a method by which the control unit 101 receives the beacon may be whichever of active scanning and passive scanning. In addition, at this time, if a beacon received by the control unit 101 is a single-link beacon of 2.4 GHz, for example, the beacon includes information in FIG. 3A that is transmitted by the AP 200-1, and information in FIG. 3B that is transmitted by the AP 200-2. In addition, if a beacon received by the control unit 101 is a single-link beacon of 5 GHz, for example, the beacon includes information in FIG. 3C that is transmitted by the AP 200-2. In addition, if a beacon received by the control unit 101 is a single-link beacon of 6 GHz, for example, the beacon includes information in FIG. 3D that is transmitted by the AP 200-2. In addition, if a beacon received by the control unit 101 is an MLO beacon, for example, the beacon includes information in FIG. 3E that is transmitted by the AP 200-2.

In step S412, the control unit 101 acquires an SSID from the beacon received in step S411.

For example, in a case where the beacon includes information for 2.4 GHz that is illustrated in FIG. 3A, an SSID 301 is SSID_A_2.4G, and in a case where the beacon includes information for 2.4 GHz that is illustrated in FIG. 3B, similarly, an SSID 311 is SSID_B_2.4G.

In addition, in a case where the beacon includes information for 5 GHz that is illustrated in FIG. 3C, an SSID 321 is SSID_B_5G. In addition, in a case where the beacon includes information for 6 GHz that is illustrated in FIG. 3D, an SSID 331 is SSID_B_6G. In addition, in a case where the beacon includes information for an MLO that is illustrated in FIG. 3E, an SSID 341 is SSID_B.

In step S413, the control unit 101 acquires a BSSID from the beacon received in step S411. Normally, a media access control (MAC) address is stored in a BSSID. For example, in a case where the beacon includes information for 2.4 GHz that is illustrated in FIG. 3A, a BSSID 302 is 000000000024, and in a case where the beacon includes information for 2.4 GHz that is illustrated in FIG. 3B, similarly, a BSSID 312 is 100000000024. In addition, in a case where the beacon includes information for 5 GHz that is illustrated in FIG. 3C, a BSSID 322 is 100000000050. In addition, in a case where the beacon includes information for 6 GHz that is illustrated in FIG. 3D, a BSSID 332 is 100000000060.

In addition, in a case where the beacon includes information for an MLO that is illustrated in FIG. 3E, a BSSID 342 is 100000000024.

In step S414, the control unit 101 acquires channel information from the beacon received in step S411. For example, in a case where the beacon includes information for 2.4 GHz that is illustrated in FIG. 3A, a channel 304 is 6, and in a case where the beacon includes information for 2.4 GHz that is illustrated in FIG. 3B, similarly, a channel 314 is 5.

In step S415, the control unit 101 acquires frequency band information from the channel information acquired in step S415. For example, because the channel 304 acquired in step S414 is 6, the control unit 101 acquires 2.4 GHz as a frequency band, and because the channel 314 acquired in step S414 is 5, similarly, the control unit 101 acquires 2.4 GHz as a frequency band.

In step S416, the control unit 101 acquires an IE from the beacon received in step S411. Normally, an IE includes information indicating whether the received beacon is an MLO-supported beacon. For example, in a case where the beacon includes information for 2.4 GHz that is illustrated in FIG. 3A, an IE 303 indicates that an MLO is unsupported, and in a case where the beacon includes information for 2.4 GHz that is illustrated in FIG. 3B, similarly, an IE 313 indicates that an MLO is unsupported. In addition, in a case where the beacon includes information for 5 GHz that is illustrated in FIG. 3C, an IE 323 indicates that an MLO is unsupported. In addition, in a case where the beacon includes information for 6 GHz that is illustrated in FIG. 3D, an IE 333 indicates that an MLO is unsupported. In addition, in a case where the beacon includes information for an MLO that is illustrated in FIG. 3E, an IE 343 indicates that an MLO is supported.

In step S417, the control unit 101 determines whether the beacon is an MLO-supported beacon, based on the IE acquired in step S416. In a case where the control unit 101 determines whether the beacon is an MLO-unsupported beacon (NO in step S417), the control unit 101 advances the processing to step S418. In a case where the control unit 101 determines whether the beacon is an MLO-supported beacon (YES in step S417), the control unit 101 advances the processing to step S419. The processing will be described using the examples of an ID for 2.4 GHz that is illustrated in FIG. 3A, and an ID for an MLO that is illustrated in FIG. 3E. The IE 303 illustrated in FIG. 3A indicates that an MLO is unsupported (i.e., does not include MLO-supported information). Accordingly, the control unit 101 advances the processing to step S418. The IE 343 illustrated in FIG. 3E indicates that an MLO is supported (i.e., includes MLO-supported information). Accordingly, the control unit 101 advances the processing to step S419.

In step S418, the control unit 101 stores the information acquired in steps S412 to S416, as a single-link beacon. A region into which the information is to be stored at this time is the working memory 103 or the nonvolatile memory 102. In this example, information illustrated in FIGS. 3A, 3B, 3C, or 3D is stored as a single-link beacon.

In step S419, the control unit 101 acquires an RNR from the beacon received in step S411.

In step S420, the control unit 101 acquires channel information from the RNR acquired in step S419. For example, in a case where the beacon includes information for an MLO that is illustrated in FIG. 3E, a channel 345 is 36 and a channel 347 is 37.

In step S421, the control unit 101 acquires frequency band information from the channel information acquired in step S420. Because the channel 345 acquired in step S420 is 36, the control unit 101 acquires 5 GHz as a frequency band, and because the channel 347 acquired in step S420 is 37, similarly, the control unit 101 acquires 6 GHz as a frequency band.

In step S422, the control unit 101 acquires a BSSID from the RNR acquired in step S419. For example, in a case where the beacon includes information for an MLO that is illustrated in FIG. 3E, a BSSID 346 included in the RNR is 100000000050, and a BSSID 348 is 100000000060.

In step S423, the control unit 101 stores the information acquired in steps S412 to S416 and steps S420 to S422, as a multi-link beacon. A region into which the information is to be stored at this time is the working memory 103 or the nonvolatile memory 102. In this example, information illustrated in FIG. 3E is stored as a multi-link beacon.

In step S424, the control unit 101 determines whether the reception of all beacons transmitted by APs existing in the vicinity has been completed. In a case where the control unit 101 determines that the reception has been completed (YES in step S424), the processing ends. In a case where the control unit 101 determines that the reception has not been completed (NO in step S424), the control unit 101 executes the processing again from step S411.

FIG. 4C is a flowchart illustrating processing to be executed when the communication apparatus 100 according to the present embodiment manages related AP information in association, and illustrates the details of the processing in step S403 of FIG. 4A.

In step S431, the control unit 101 acquires a BSSID from the multi-link beacon stored in step S423. The BSSID to be acquired in the present embodiment includes, for example, the BSSID 342, the BSSID 346, and the BSSID 348 in FIG. 3E.

In step S432, the control unit 101 acquires an SSID from the single-link beacon stored in step S418. The SSID to be acquired in the present embodiment includes, for example, the SSID 301 in FIG. 3A, the SSID 311 in FIG. 3B, the SSID 321 in FIG. 3C, and the SSID 331 in FIG. 3D.

In step S433, the control unit 101 acquires a BSSID from the single-link beacon stored in step S418. The BSSID to be acquired in the present embodiment includes, for example, the BSSID 302 in FIG. 3A, the BSSID 312 in FIG. 3B, the BSSID 322 in FIG. 3C, and the BSSID 332 in FIG. 3D.

In step S434, the control unit 101 determines whether the multi-link BSSID acquired in step S431, and the single-link BSSID acquired in step S433 match. In step S434, the control unit 101 determines that the BSSIDs match (YES in step S434), the control unit 101 advances the processing to step S435. In step S434, the control unit 101 determines that the BSSIDs do not match (NO in step S434), the control unit 101 advances the processing to step S436. The processing will be described using examples of the BSSID 302 and the BSSID 312 for 2.4 GHz, the BSSID 322 for 5 GHz, the BSSID 332 for 6 GHz, and the BSSID 342, the BSSID 346, and the BSSID 348 for an MLO. The BSSID 302 for 2.4 GHz is 000000000024, which matches none of the BSSID 342, the BSSID 346, and the BSSID 348 for an MLO. Accordingly, the control unit 101 advances the processing to step S436. The BSSID 312 for 2.4 GHz is 100000000024, which matches 100000000024 being the BSSID 342 for an MLO. Accordingly, the control unit 101 advances the processing to step S435. The BSSID 322 for 5 GHz is 100000000050, which matches 100000000050 being the BSSID 346 for an MLO. Accordingly, the control unit 101 advances the processing to step S435. The BSSID 332 for 6 GHz is 100000000060, which matches 100000000060 being the BSSID 348 for an MLO. Accordingly, the control unit 101 advances the processing to step S435.

In step S435, the control unit 101 stores the multi-link information and the single-link information matching in the comparison in step S434, in association with each other. The information to be stored at this time is, for example, information as illustrated in FIG. 5A, and is stored in the working memory 103 or the nonvolatile memory 102. The processing will be described using examples of the BSSID 312 for 2.4 GHz, the BSSID 322 for 5 GHz, the BSSID 332 for 6 GHz, and the BSSID 342, the BSSID 346, and the BSSID 348 for an MLO. Because it is determined in step S434 that the BSSID 312 for 2.4 GHz matches the BSSID 342 for an MLO, it is determined that the beacons are beacons transmitted from the same AP, and are stored in association. The information to be stored at this time is information 501 in FIG. 5A. In addition, because it is determined in step S434 that the BSSID 322 for 5 GHz matches the BSSID 346 for an MLO, it is determined that the beacons are beacons transmitted from the same AP, and are stored in association. The information to be stored at this time is information 502 in FIG. 5A. In addition, because it is determined in step S434 that the BSSID 332 for 6 GHz matches the BSSID 348 for an MLO, it is determined that the beacons are beacons transmitted from the same AP, and are stored in association. The information to be stored at this time is information 503 in FIG. 5A. In this manner, by storing multi-link information and single-link information in association, it becomes possible to manage the information as beacons transmitted by the same AP. In addition, at this time, there is no need to associate all pieces of multi-link information and single-link information, and as illustrated in FIG. 5B, single-link information 511 and multi-link information 512 may be separately managed.

In step S436, the control unit 101 determines whether all single-link beacons stored in step S418 have been acquired. In a case where the control unit 101 determines that all single-link beacons have been acquired (YES in step S436), the control unit 101 advances the processing to step S437. In a case where the control unit 101 determines that all single-link beacons have not been acquired (NO in step S436), the control unit 101 executes the processing again from step S432, and searches for single-link information matching acquired multi-link information.

In step S437, the control unit 101 determines whether all multi-link beacons stored in step S423 have been acquired. In a case where the control unit 101 determines that all multi-link beacons have been acquired (YES in step S437), the control unit 101 ends the processing. In a case where the control unit 101 determines that all multi-link beacons have not been acquired (NO in step S437), the control unit 101 executes the processing again from step S431, and performs association of new multi-link information and single-link information.

Heretofore, AP information association processing to be executed by the communication apparatus 100 according to the present embodiment has been described.

### Display Processing of AP Information Associated by Communication Apparatus 100

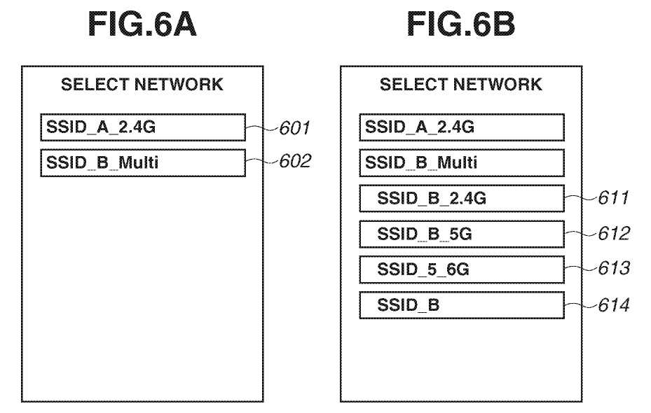

Next, processing in which the communication apparatus 100 according to the present embodiment displays associated AP information will be described with reference to FIGS. 6A-6B to FIGS. 10A-10B.

FIG. 6A illustrates an example of a screen displaying, on the display unit 105, AP information associated by the control unit 101 according to the present embodiment, gathered into one. An SSID 601 indicates information stored in step S418 of FIG. 4B by the control unit 101 as single-link information, and not having been associated with multi-link information. An SSID to be displayed at this time is the SSID 301 in FIG. 3A. An SSID 602 indicates information in FIG. 5A that is stored in step S435 of FIG. 4C by the control unit 101 in association. An SSID to be displayed at this time is any of single-link SSIDs stored in association, a multi-link SSID, an SSID (an example of group information) of which a name has been changed in such a manner as to indicate an associated state, or the like.

FIG. 6B illustrates an example of a screen to be displayed in a case where AP information associated by the control unit 101 according to the present embodiment is selected using the operation unit 104. At this time, the control unit 101 acquires information indicating that the SSID 602 has been selected, from the operation unit 104, and displays the screen illustrated in FIG. 6B, on the display unit 105.

If the control unit 101 detects the selection of the SSID 602, the control unit 101 displays all single-link SSIDs and multi-link SSIDs associated with the SSID 602, on the display unit 105. An SSID 611 corresponds to the information 501 in FIG. 5A that has been stored in step S435 of FIG. 4C by the control unit 101 in association. An SSID 612 corresponds to the information 502 in FIG. 5A that has been stored in step S435 of FIG. 4C by the control unit 101 in association. An SSID 613 corresponds to the information 503 in FIG. 5A that has been stored in step S435 of FIG. 4C by the control unit 101 in association.

An SSID 614 corresponds to information 504 in FIG. 5A that has been stored in step S435 of FIG. 4C by the control unit 101 in association. In this manner, in a case where AP information associated and displayed with being gathered into one is selected, the communication apparatus 100 according to the present embodiment can expand and display all pieces of associated AP information.

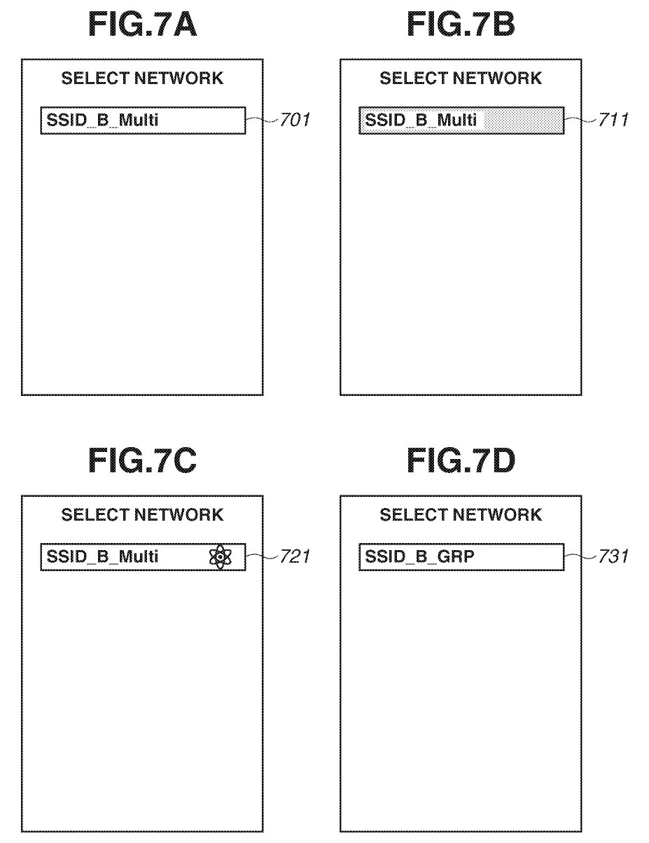

FIGS. 7A to 7D illustrate an example of a screen displaying that AP information is AP information associated by the control unit 101 according to the present embodiment, on the display unit 105 in an easy-to-understand manner. In FIG. 7A, an SSID 701 is displayed in boldface to display that the SSID 701 is associated AP information, in an easy-to-understand manner. In FIG. 7B, an SSID 711 is displayed with a changed background color to display that the SSID 711 is associated AP information, in an easy-to-understand manner. In FIG. 7C, an icon is displayed to display that an SSID 721 is associated AP information, in an easy-to-understand manner. In FIG. 7D, a display name is changed and displayed to display that an SSID 731 is associated AP information, in an easy-to-understand manner. In this manner, in order to display that an SSID is associated AP information, in an easy-to-understand manner, the communication apparatus 100 according to the present embodiment can display the SSID while distinguishing the SSID from unassociated AP information. In addition, a method of displaying information in an easy-to-understand manner is not limited to this. The displaying information in an easy-to-understand manner differentiates display modes of associated AP information and unassociated AP information. For example, it is desirable to display AP information in such a manner that the user can easily recognize that the AP information is associated AP information, but the display mode is not limited to the examples illustrated in FIGS. 7A-7D.

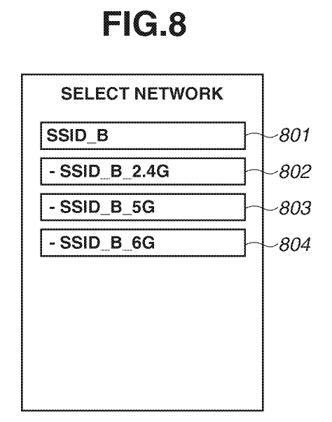

FIG. 8 illustrates an example of a screen displaying that AP information pieces associated by the control unit 101 according to the present embodiment are related, on the display unit 105 without gathering the AP information pieces. An SSID 801 indicates a multi-link SSID among pieces of AP information associated by the control unit 101. An SSID 802 indicates an SSID for 2.4 GHz among pieces of AP information associated by the control unit 101. An SSID 803 indicates an SSID for 5 GHz among pieces of AP information associated by the control unit 101. An SSID 804 indicates an SSID for 6 GHz among pieces of AP information associated by the control unit 101. In this example, to indicate that the SSIDs 801 to 804 are associated AP information, when the other SSIDs are displayed below the representative SSID 801, the SSIDs are displayed using indents and hyphens. In this manner, the communication apparatus 100 according to the present embodiment can display that associated AP information pieces are related, without gathering the AP information pieces. In addition, a method of displaying that information pieces are related is not limited to this.

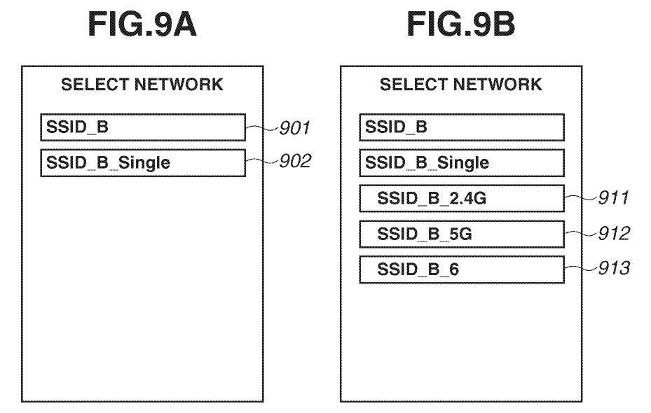

FIG. 9A illustrates an example of a screen displaying a multi-link SSID and a single-link SSID associated by the control unit 101 one by one on the display unit 105. An SSID 901 indicates information stored in step S435 of FIG. 4C by the control unit 101 in association. An SSID to be displayed at this time is a multi-link SSID stored in association. An SSID 902 indicates information stored in step S435 of FIG. 4C by the control unit 101 in association. An SSID to be displayed at this time is any of single-link SSIDs stored in association, a multi-link SSID, an SSID of which a name has been changed in such a manner as to indicate an associated state, or the like. FIG. 9B illustrates an example of a screen to be displayed in a case where AP information associated by the control unit 101 according to the present embodiment is selected using the operation unit 104. At this time, the control unit 101 acquires information indicating that the SSID 902 has been selected, from the operation unit 104, and displays the screen illustrated in FIG. 9B, on the display unit 105. If the control unit 101 detects the selection of the SSID 902, the control unit 101 displays all single-link SSIDs associated with the SSID 902, on the display unit 105. SSIDs 911 to 913 are single-link SSIDs stored in step S435 of FIG. 4C by the control unit 101 in association. In this manner, the communication apparatus 100 according to the present embodiment can gather single-link SSIDs into one view, and display the single-link SSIDs separately from a multi-link SSID. In addition, a method of displaying single-link SSIDs separately from a multi-link SSID is not limited to this.

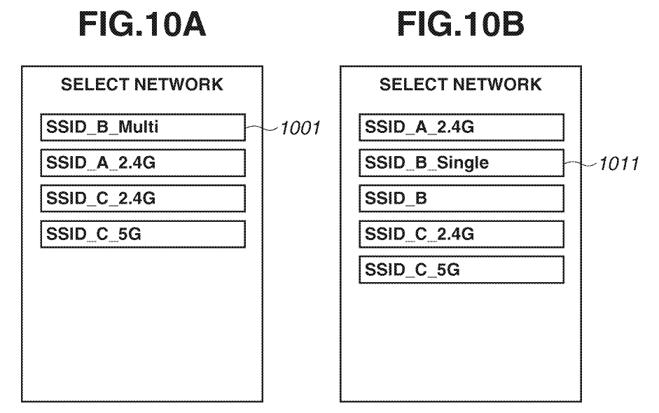

FIG. 10A illustrates an example of a screen displaying AP information associated by the control unit 101 according to the present embodiment, on the display unit 105 with the associated AP information existing on the top of all pieces of AP information, when displaying pieces of associated AP information in a gathered manner.

An SSID 1001 indicates information stored in step S435 of FIG. 4C by the control unit 101 in association. An SSID to be displayed at this time is any of single-link SSIDs stored in association, a multi-link SSID, an SSID of which a name has been changed in such a manner as to indicate an associated state, or the like. Normally, an arrangement order in displaying AP information as a list is an ascending order of SSIDs, a connection history-based order, a radio field intensity-based order, or the like, and the communication apparatus 100 according to the present embodiment can display AP information associated and gathered into one, in such a manner as to come on the top of all pieces of AP information. In addition, in a case where there is a plurality of sets of AP information associated and gathered into one, the AP information may be arranged in an SSID ascending order of gathered AP information, a connection history-based order, a radio field intensity-based order, or the like.

FIG. 10B illustrates an example of a screen displaying, on the display unit 105, AP information associated by the control unit 101 according to the present embodiment, with gathered single-link SSIDs, existing on the top of pieces of associated AP information, when gathering single-link SSIDs into one and displaying the gathered single-link SSIDs. An SSID 1011 indicates information stored in step S435 of FIG. 4C by the control unit 101 in association. An SSID to be displayed at this time is any of single-link SSIDs stored in association, an SSID of which a name has been changed in such a manner as to indicate an associated state, or the like. In this manner, in a case where there are SSIDs to be displayed with being gathered into one, among pieces of AP information stored in association, the communication apparatus 100 according to the present embodiment can display the gathered SSIDs in such a manner as to exist above the other SSIDs to be displayed without being gathered.

Heretofore, processing in which the communication apparatus 100 according to the present embodiment displays associated AP information has been described.

### Second Embodiment

Hereinafter, processing in which, in a case where information included in an Information Element included in a single-link beacon transmitted from an MLO-supported AP is an MLO-supported information, a communication apparatus 100 preferentially displays the information will be described.

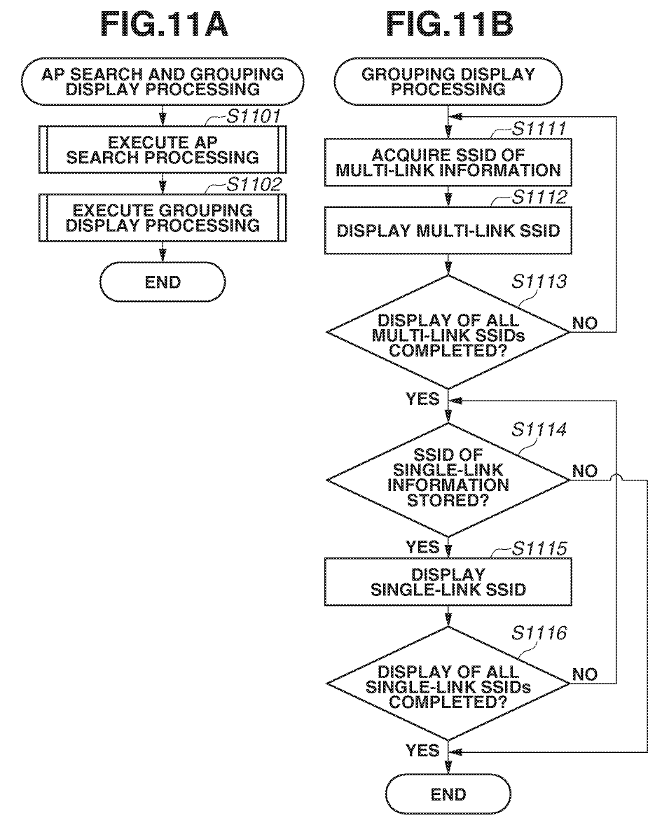

First of all, processing of associating MLO-adapted SSIDs of AP information that is to be executed by a communication apparatus 100 according to the present embodiment will be described with reference to FIGS. 11A and 11B.

FIG. 11A is a flowchart illustrating processing to be executed when the communication apparatus 100 according to the present embodiment executes AP search.

The processing in step S1101 is the processing described in the above-described first embodiment with reference to FIG. 4B. The description here will be omitted because the processing has already been described.

The processing in step S1102 is processing of collectively displaying MLO-connectable APs, among APs found in step S1101, which is a characteristic part of the second embodiment. The detailed description will be given below with reference to FIGS. 11B and 4B.

FIG. 11B is a flowchart illustrating processing of collectively displaying MLO-connectable APs.

In step S1111, a control unit 101 acquires multi-link information stored in step S423, from the working memory 103 or the nonvolatile memory 102.

In step S1112, the control unit 101 displays the multi-link SSID acquired in step S1111, on the display unit 105.

In step S1113, the control unit 101 checks whether the display of all multi-link SSIDs has been completed, based on the multi-link information acquired in step S1111 described above. If there is a multi-link SSID that has not been displayed yet (NO in step S1113), the processing returns to step S1111, and the processing is repeated until the display of all multi-link SSIDs is completed. In a case where the display of all multi-link SSIDs has been completed (YES in step S1113), the processing proceeds to step S1114.

In step S1114, the control unit 101 checks whether the single-link SSID stored in step S418 is stored in the working memory 103 or the nonvolatile memory 102. In a case where an SSID of single-link information does not exist (NO in step S1114), the processing ends. In a case where an SSID of single-link information exists (YES in step S1114), the processing proceeds to step S1115.

In step S1115, the control unit 101 displays a single-link SSID after the multi-link SSID displayed in step S1112.

In step S1116, the control unit 101 checks whether the display of all single-link SSIDs has been completed. If there is a single-link SSID that has not been displayed (NO in step S1116), the processing returns to step S1114, and the processing is repeated. In a case where the display of all single-link SSIDs has been completed (YES in step S1116), the processing ends.

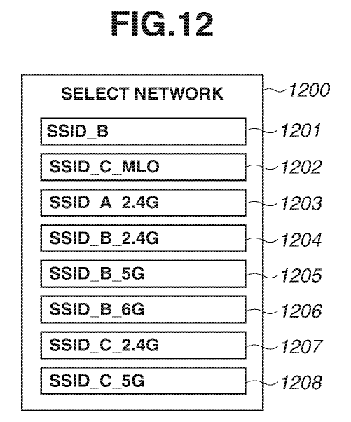

FIG. 12 illustrates a state in which multi-link SSIDs described with reference to FIG. 11B are associated and displayed.

A screen 1200 is a screen to be displayed when network connection is performed on the display unit 105. Received SSIDs of APs are displayed on the screen 1200.

An SSID 1201 is an SSID received from the AP 200-2, and corresponds to the SSID illustrated in FIG. 3E.

By the processing of collectively displaying multi-link SSIDs that has been performed in step S1112, multi-link SSIDs are displayed at a higher rank than a single-link SSID, and the SSID 341 is displayed as a display name.

An SSID 1202 indicates that an SSID received from the AP 200-3 is a multi-link SSID, and an SSID 371 is displayed. The processing described so far corresponds to the processing of collectively displaying multi-link SSIDs that has been described with reference to FIG. 11B, and has been performed in step S1102 described above.

An SSID 1203 is an SSID received from the AP 200-1, and the SSID 301 in FIG. 3A is displayed.

An SSID 1204 is an SSID received from the AP 200-2, and the SSID 311 in FIG. 3B is displayed.

An SSID 1205 is an SSID received from the AP 200-2, and the SSID 321 in FIG. 3C is displayed.

An SSID 1206 is an SSID received from the AP 200-2, and the SSID 331 in FIG. 3D is displayed.

An SSID 1207 is an SSID received from the AP 200-3, and an SSID 351 in FIG. 3F is displayed.

An SSID 1208 is an SSID received from the AP 200-3, and an SSID 361 in FIG. 3G is displayed.

The SSIDs 1203 to 1208 indicate the SSIDs in the processing described above with reference to step S1114.

As described above, the communication apparatus 100 according to the present embodiment preferentially displays the associated multi-link AP information over the associated single-link AP information on the display unit 105, whereby it becomes possible for the user to easily find a multi-link AP.

In other words, the communication apparatus 100 according to the present embodiment displays the associated multi-link AP information at a higher rank than the associated single-link AP information on the display unit 105, whereby it becomes possible for the user to easily find a multi-link AP. This is an example of a general display screen on which an AP existing in an upper part is more easily recognized by the user. On such a display screen, in a case where the number of SSIDs exceeds a predefined number, by the user performing a scroll operation, SSIDs existing in a lower part are displayed. That is, unless the number of multi-link APs exceeds a predefined number, the user can find a multi-link AP without scrolling the screen.

Nevertheless, a display screen on which APs existing in a lower part are easily recognized by the user, or a display screen on which APs existing in a left or right part are easily recognized by the user are also expected. In such a case, associated multi-link AP information need not be displayed at a higher rank than associated single-link AP information. For example, in the case of the display screen on which APs existing in a lower part are easily recognized by the user, associated multi-link AP information may be displayed at a lower rank than associated single-link AP information. With this configuration, the user can easily find a multi-link AP.

In addition, FIG. 11B illustrates an example of displaying single-link SSIDs after the display of all multi-link SSIDs is completed, but display processing according to the present embodiment is not limited to this example. As long as multi-link SSIDs are displayed preferentially over (at a higher rank than) single-link SSIDs, multi-link and single-link SSIDs may be displayed in the order of APs found by AP search processing.

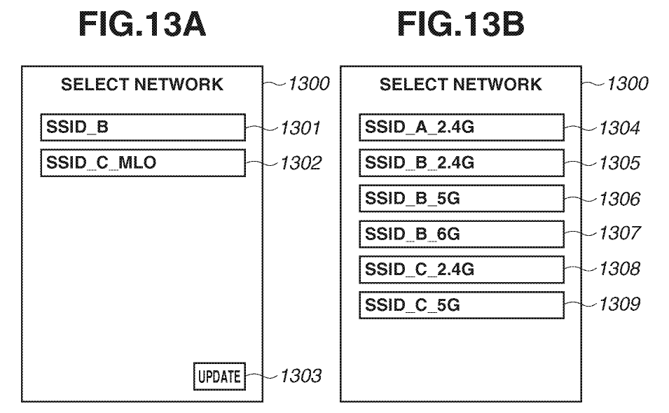

Hereinafter, a method of displaying an MLO-connectable SSID, as an SSID to be displayed on a screen, and not displaying the other SSIDs on the same screen, when displaying an MLO-connectable SSID on a screen will be described with reference to FIGS. 13A-13B and 11B.

Because the method of receiving a beacon and acquiring multi-link information and single-link information from an IE is similar to the method described in the first embodiment, the description will be omitted.

In step S1111, the control unit 101 acquires an SSID of multi-link information, and in step S1112, the control unit 101 displays a multi-link SSID on the display unit 105. FIG. 13A illustrates displayed SSIDs.

A display screen 1300 illustrated in FIG. 13A is similar to the screen 1200, and indicates a screen on which network connection is performed on the display unit 105. An SSID 1301 is an SSID received from the AP 200-2, and corresponds to the SSID illustrated in FIG. 3E. The SSID 1301 indicates a multi-link SSID, and the SSID 341 (SSID_B) is displayed.

An SSID 1302 is an SSID received from the AP 200-3, and corresponds to the SSID illustrated in FIG. 3H. The SSID 1302 also indicates a multi-link SSID, and the SSID 371 (SSID_C_MLO) is displayed.

In the example according to the present embodiment, because an MLO-connectable SSID is displayed, a single-link SSID is not displayed on the screen.

An icon 1303 is an update icon. By pressing the icon 1303, the display update of MLO SSIDs that have not fit into one screen is performed. In addition, in a case where all MLO SSIDs are displayed, in step S1113, a single-link SSID is checked by performing update, and if there is a single-link SSID, a single-link SSID may be displayed as illustrated in FIG. 13B.

An SSID 1304 is an SSID received from the AP 200-1, and the SSID 301 illustrated in FIG. 3A is displayed.

An SSID 1305 is an SSID received from the AP 200-2, and the SSID 311 illustrated in FIG. 3B is displayed.

An SSID 1306 is an SSID received from the AP 200-2, and the SSID 321 illustrated in FIG. 3C is displayed.

An SSID 1307 is an SSID received from the AP 200-2, and the SSID 331 illustrated in FIG. 3D is displayed.

An SSID 1308 is an SSID received from the AP 200-3, and the SSID 351 illustrated in FIG. 3F is displayed.

An SSID 1309 is an SSID received from the AP 200-3, and the SSID 361 illustrated in FIG. 3G is displayed.

By performing such display, it becomes possible to separate MLO-connectable SSIDs from other SSIDs, and it becomes possible to easily find an MLO-connectable SSID. Nevertheless, the display method of single-link SSIDs is not limited to pressing of the update icon. Single-link SSIDs may be displayed in accordance with a predetermined operation being performed by the user.

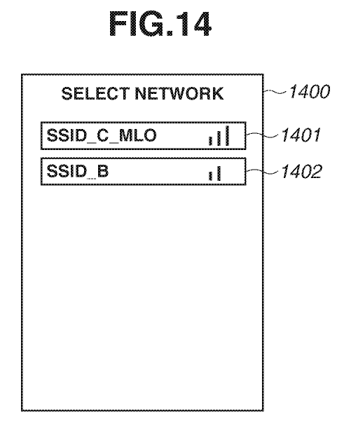

Hereinafter, a method of displaying an MLO-connectable SSID in consideration of a radio field intensity when displaying an MLO-connectable SSID will be described with reference to FIG. 14.

Because the method of receiving a beacon and acquiring multi-link information and single-link information from an IE is similar to the method described in the first embodiment, the description will be omitted.

A display screen 1400 is similar to the above-described screens 1200 and 1300, and indicates a screen on which network connection is performed on the display unit 105.

An SSID 1401 is an SSID received from the AP 200-3, and the SSID 371 illustrated in FIG. 3H is displayed.

In FIGS. 12 and 13A described above, SSIDs are arranged in alphabetical order without considering a radio field intensity and displayed, but in the present embodiment, the wireless communication unit 106 receives a radio field intensity given by each AP, and the radio field intensity is associated with an SSID and stored in the working memory 103.

A state 1401 indicates a state in which the radio field intensity associated with the SSID 371 (SSID_C_MLO) is high.

A state 1402 indicates a state in which the radio field intensity associated with the SSID 341 (SSID_B) is lower than that in the state 1401.

In addition, a method of referring to a radio field intensity can be applied also to other display screens such as the display screen illustrated in FIG. 12. For example, if the method is applied to the display screen illustrated in FIG. 12, multi-link SSIDs may be displayed in a radio field intensity order, and single-link SSIDs may be displayed below the multi-link SSIDs in a radio field intensity order.

By arranging MLO-connectable SSIDs in a radio field intensity order in this manner, it becomes possible to prompt the user to establish connection to more stable MLO communication. FIG. 14 illustrates radio field intensities, but an index indicating another connection status may be used.

Heretofore, the second embodiment has been described. According to the above-described example, the user can preferentially use an MLO-connectable AP.

### Third Embodiment

Hereinafter, processing in which a communication apparatus 100 according to the third embodiment of the present disclosure displays an AP search result list will be described with reference toFIGS. 2, 3A-3H, 15A-15B and 16A-16F .

In the present embodiment, in the network configuration illustrated in FIG. 2, a case where the communication apparatus 100 receives beacons transmitted by the AP 200-1 and the AP 200-2 will be described. That is, the communication apparatus 100 receives a beacon illustrated in FIGS. 3A, 3B, 3C, 3D, or 3E.

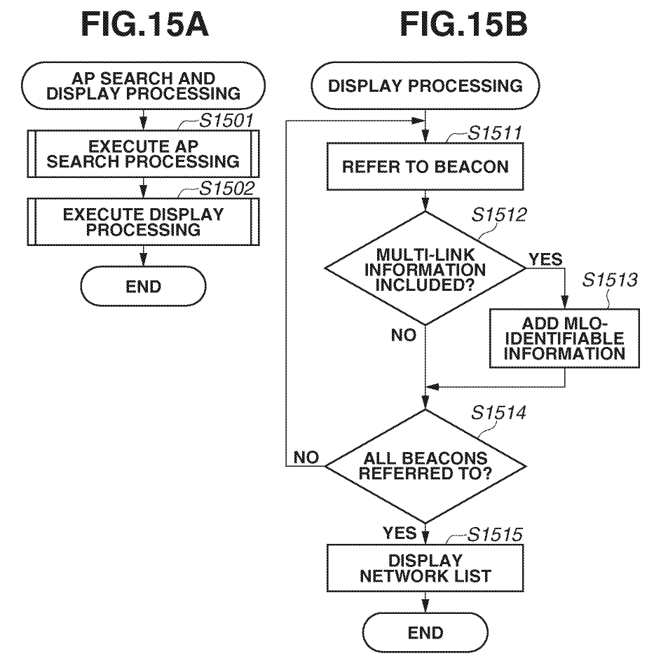

FIG. 15A is a flowchart illustrating AP search and display processing to be executed by the communication apparatus 100 according to the present embodiment. Each piece of processing in this flowchart is implemented by the control unit 101 loading a program stored in the nonvolatile memory 102, onto the working memory 103 and executing the program.

In step S1501, the control unit 101 performs AP search processing, and the processing proceeds to step S1502. Because the AP search processing is similar to the processing in the flowchart illustrated in FIG. 4B, the description will be omitted. The present embodiment describes a case where the communication apparatus 100 receives beacons transmitted by the AP 200-1 and the AP 200-2. Thus, in step S418 of FIG. 4B, the beacon in FIG. 3A (SSID_A_2.4G, channel 6, 2.4 GHz, single-link), or the beacon in FIG. 3B (SSID_B_2.4G, channel 5, 2.4 GHz, single-link) is stored. Alternatively, the beacon in FIG. 3C (SSID_B_5G, channel 36, 5 GHz, single-link), or the beacon in FIG. 3D (SSID_B_6G, channel 37, 6 GHz, single-link) is stored. Furthermore, in step S423 of FIG. 4B, the beacon in FIG. 3E (SSID_B, channel 5/36/37, 2.4 GHz/5 GHz/6 GHz, multi-link) is stored.

In step S1502, the control unit 101 performs display processing, and ends the processing. The display processing will be described with reference to FIG. 15B.

FIG. 15B is a flowchart illustrating processing of displaying an AP search result obtained by the communication apparatus 100 according to the present embodiment. Each piece of processing in this flowchart is implemented by the control unit 101 loading a program stored in the nonvolatile memory 102, onto the working memory 103 and executing the program.

In step S1511, the control unit 101 refers to the beacons stored in steps S418 and S423, and the processing proceeds to step S1512. First of all, the control unit 101 refers to the beacon illustrated in FIG. 3A.

In step S1512, the control unit 101 determines whether multi-link information is included in the beacon referred to in step S1511. In a case where the control unit 101 determines that multi-link information is included (YES in step S1512), the processing proceeds to step S1513. In a case where the control unit 101 determines that multi-link information is not included (NO in step S1512), the processing proceeds to step S1514. Because the beacon illustrated in FIG. 3A (SSID_A_2.4G, channel 6, 2.4 GHz, single-link) does not include multi-link information, the processing proceeds to step S1514.

In step S1514, the control unit 101 determines whether all the beacons stored in steps S418 and S423 have been referred to. In a case where it is determined that all the beacons have been referred to (YES in step S1514), the processing proceeds to step S1515. In a case where it is determined that all the beacons have not been referred to (NO in step S1514), the processing returns to step S1511. In this example, because the beacon in FIG. 3A has been referred to, and there is a beacon that has not been referred to (NO in step S1514), the processing returns to step S1511, and the next beacon is referred to.

Because the beacon in FIG. 3B (SSID_B_2.4G, channel 5, 2.4 GHz, single-link) does not include multi-link information either, the processing is performed in the order of steps S1512 and S1514. In addition, because the beacon in FIG. 3C (SSID_B_5G, channel 36, 5 GHz, single-link) does not include multi-link information either, the processing is performed in the order of steps S1512 and S1514. In addition, because the beacon in FIG. 3D (SSID_B_6G, channel 37, 6 GHz, single-link) does not include multi-link information either, the processing is performed in the order of steps S1512 and S1514.

Next, in step S1511, the beacon in FIG. 3E is referred to. Because the beacon in FIG. 3E (SSID_B, channel 5/36/37, 2.4 GHz/5 GHz/6 GHz, multi-link) includes multi-link information, in step S1512, the control unit 101 determines that multi-link information is included (YES in step S1512), the processing proceeds to step S1513.

In step S1513, the control unit 101 adds information that makes an MLO-supported network identifiable, to the beacon referred to in step S1511, and the processing proceeds to step S1514.

In step S1514, the control unit 101 determines whether all the received beacons illustrated in FIGS. 3A to 3E have been referred to, and in a case where all the beacons have been referred to (YES in step S1514), the processing proceeds to step S1515.

In step S1515, the control unit 101 display a network list on the display unit 105, and ends the processing.

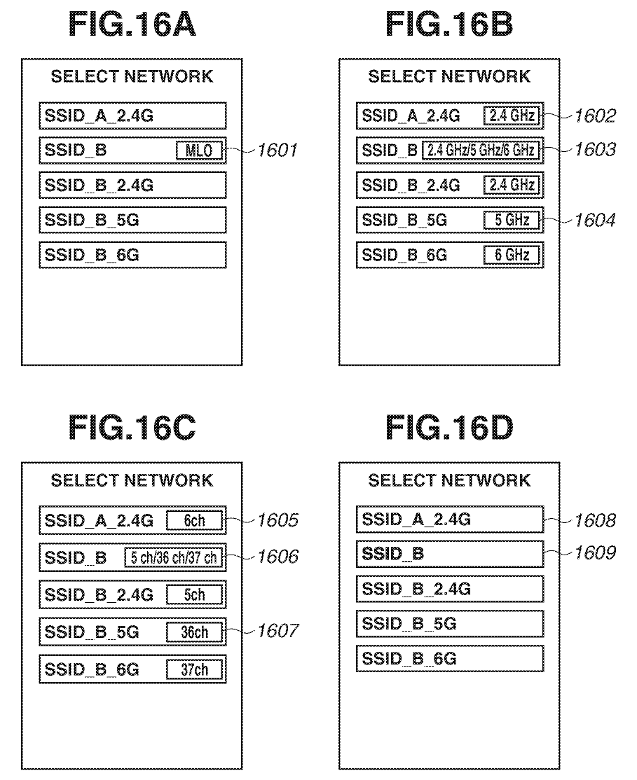

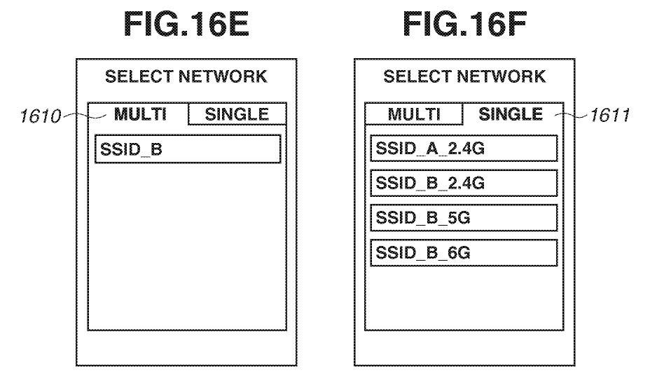

The detailed example of adding of information that makes an MLO-supported network identifiable, and network list display in steps S1513 and S1515 will be described with reference to FIGS. 16A-16F.

FIGS. 16A-16F are diagrams each exemplifying a screen to be displayed on the display unit 105 of the communication apparatus 100 according to the present embodiment.

FIG. 16A illustrates an example in which an icon labeled MLO is added in network list display as information that makes an MLO-supported network identifiable. As indicated by an icon 1601 in FIG. 16A, an icon indicating that a network is an MLO-supported network is displayed next to an SSID (SSID_B) of an MLO-supported network. In the present embodiment, an icon labeled MLO is added, but the information is not limited to the icon because the information is identification information that makes an MLO-supported network identifiable. In addition, the position where the icon is displayed is not limited to the position next to the SSID. The icon is displayed at a position corresponding to the SSID.

FIG. 16B illustrates an example in which frequency band information is displayed side by side in network list display as information that makes an MLO-supported network identifiable. As indicated by frequency bands 1602 and 1604 in FIG. 16B, 2.4 GHz and 5 GHz are displayed for SSID_A_2.4G and SSID_B_5G, which are single-link networks.

In contrast to this, frequency band information is displayed side by side like 2.4 GHz/5 GHz/6 GHz for SSID_B, which is an MLO-supported network. In the present embodiment, because the network with SSID_B is an MLO-supported network of 2.4 GHz, 5 GHz, and 6 GHz, 2.4 GHz/5 GHz/6 GHz is displayed. On the other hand, if the network is an MLO-supported network of 2.4 GHz and 5 GHz, 2.4 GHz/5 GHz is displayed. In addition, if the network is an MLO-supported network of 2.4 GHz and 6 GHz, 2.4 GHz/6 GHz is displayed. In addition, the network is an MLO-supported network of 5 GHz and 6 GHz, 5 GHz/6 GHz is displayed. In addition, because it is sufficient that an MLO-supported network is identifiable, the description of frequency band information arranged side by side is not limited to this.

FIG. 16C illustrates an example in which channel information is displayed side by side in network list display as information that makes an MLO-supported network identifiable. As indicated by channels 1605 and 1607 in FIG. 16C, the respective channels are displayed like 6ch and 36ch for SSID_A_2.4G and SSID_B_5G, which are single-link networks. In contrast to this, channel information is displayed side by side like 5ch/36ch/37ch for SSID_B, which is an MLO-supported network. In the present embodiment, because the network with SSID_B is an MLO-supported network of 5ch, 36ch, and 37ch, 5ch/36ch/37ch is displayed. Nevertheless, because a combination of channels varies depending on channels to which an MLO-supported network corresponds, the combination is not limited to this. In addition, because it is sufficient that an MLO-supported network is identifiable, the description of channel information arranged side by side is not limited to this.

FIG. 16D illustrates an example in which an SSID of an MLO-supported network is displayed in a highlighted manner in network list display in such a manner that an MLO-supported network is identifiable. As compared with SSID_A_2.4G being a single-link network and indicated by an SSID 1608 in FIG. 16D, characters of SSID_B being an MLO-supported network are displayed in a larger size as indicated by an SSID 1609 in FIG. 16D. In the present embodiment, an example in which the characters of an SSID are displayed in a larger size has been described, but because it is sufficient that an MLO-supported network is identifiable, the description is not limited to this. For example, another method of highlighting an SSID such as changing the color of characters of an SSID of an MLO-supported network to a color different from the color of characters of a single-link SSID, or thickening the characters of an SSID of an MLO-supported network may be employed.

FIGS. 16E and 16F illustrate an example of separately displaying a screen for an MLO-supported network list and a screen for a single-link network list in network list display in such a manner that an MLO-supported network is identifiable. If a tab of multi is selected as indicated by a tab 1610 in FIG. 16E (an example of a second display operation), an MLO-supported network list (an example of a second network selection screen) is displayed. In addition, if a tab of single is selected as indicated by a tab 1611 in FIG. 16F (an example of a first display operation), a single-link network list (an example of a first network list screen) is displayed. An initial screen displaying a network selection screen may be the screen illustrated in the tab 1610 in FIG. 16E. This can enable the user to preferentially connect to an MLO-supported network.

Heretofore, the processing in which the communication apparatus 100 according to the present embodiment displays an AP search result list has been described.

As described above, in the present embodiment, when displaying an AP search result list, by displaying, in an identifiable manner, whether the displayed network is an MLO-supported network, the user can select an MLO-supported network and connect thereto.

Heretofore, desirable embodiments of the present disclosure have been described, but the present disclosure is not limited to these embodiments, and various modifications and changes can be made without the gist thereof.

For example, the first embodiment, the second embodiment, and the third embodiment may be combined. Specifically, it is expected to combine the processing according to the second embodiment, with the processing according to the first embodiment or the third embodiment. More specifically, by performing association processing according to the first embodiment, an SSID of the same AP illustrated in FIG. 12 may be displayed in an identifiable manner using color or the like. By further combining with the third embodiment, an SSID may be displayed in such a manner that a multi-link SSID is identifiable.

In addition, various display screens according to the first embodiment that are illustrated in FIGS. 6A to 10B may include identification information (for example, icon) indicating that information is multi-link information, or identification information (for example, icon) indicating that information is single-link information.

Heretofore, a specific example of a combination of a plurality of embodiments has been described, but the combination is not limited to the above-described example.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-190705, filed October 30, 2024, which is hereby incorporated by reference herein in its entirety.

WHAT IS CLAIMED IS:

1. A communication apparatus that wirelessly communicates with a communication partner apparatus, the communication apparatus comprising:
a processor; and
a memory storing a program which, when executed by the processor, causes the communication apparatus to:
execute search processing that searches for the communication partner apparatus; and
execute display control processing that controls a display unit to display predetermined beacon information in a manner that enables the predetermined beacon information to be identified as being multi-link-supported information when a plurality of pieces of beacon information obtained by search performed includes the predetermined beacon information including support information indicating that information is multi-link-supported information.

2. The communication apparatus according to claim 1, wherein the display control processing controls the display unit to display identification information indicating that the predetermined beacon information is the multi-link-supported information at a position corresponding to an identification name corresponding to the predetermined beacon information.

3. The communication apparatus according to claim 2, wherein the identification information is an icon indicating that the predetermined beacon information is the multi-link-supported information.

4. The communication apparatus according to claim 3, wherein the icon includes frequency band information to which the predetermined beacon information corresponds in a multi-link.

5. The communication apparatus according to claim 1, wherein the display control processing further controls the display unit to display an identification name corresponding to the beacon information, and controls the display unit not to display different identification information indicating that the beacon information is not multi-link-supported information when a plurality of pieces of beacon information obtained by search performed includes beacon information not including the support information.

6. The communication apparatus according to claim 1, wherein, the display control processing controls the display unit to display an identification name corresponding to the beacon information and different identification information indicating that the beacon information is not multi-link-supported information when a plurality of pieces of beacon information obtained by search performed includes beacon information not including the support information.

7. The communication apparatus according to claim 6, wherein the different identification information includes frequency band information to which the beacon information corresponds in a single-link.

8. The communication apparatus according to claim 1, wherein the display control processing controls the display unit to display an identification name corresponding to the predetermined beacon information, while highlighting the identification name more than an identification name corresponding to beacon information not including the support information.

9. The communication apparatus according to claim 1, wherein, when a first display operation is performed, the display control processing controls the display unit to display a first network selection screen including an identification name corresponding to beacon information not including the support information, and not including an identification name corresponding to the predetermined beacon information.

10. The communication apparatus according to claim 9, wherein, when a second display operation is performed on the first network selection screen, the display control processing controls the display unit to display a second network selection screen not including an identification name corresponding to beacon information not including the support information, and including an identification name corresponding to the predetermined beacon information.

11. A control method of controlling a communication apparatus that can wirelessly communicate with a communication partner apparatus, the control method comprising:
searching for the communication partner apparatus; and
controlling a display unit to display predetermined beacon information in a manner that enables the predetermined beacon information to be identified as being the multi-link-supported information when a plurality of pieces of beacon information obtained by the searching includes the predetermined beacon information including support information indicating that information is multi-link-supported information.

12. A non-transitory computer readable medium that stores a program, wherein the program causes a computer to execute a control method of controlling a communication apparatus that can wirelessly communicate with a communication partner apparatus, the control method comprising:
searching for the communication partner apparatus; and
controlling a display unit to display predetermined beacon information in a manner that enables the predetermined beacon information to be identified as being the multi-link-supported information when a plurality of pieces of beacon information obtained by the searching includes the predetermined beacon information including support information indicating that information is multi-link-supported information.
